(19) United States
(12) Patent Application Publication
(10) Pub. No.: US 2024/0166937 A1
(43) Pub. Date: May 23, 2024

(54) FLUID LOSS CONTROL PILLS USING CALCIUM CARBONATE PARTICLES FORMED FROM SEQUESTERED CARBON DIOXIDE

(71) Applicant: Chevron U.S.A. Inc., San Ramon, CA (US)

(72) Inventors: Oya Aysen Karazincir, Houston, TX (US); Sandra Liliana Gomez-Nava, Katy, TX (US)

(21) Appl. No.: 18/056,453

(22) Filed: Nov. 17, 2022

(51) Int. Cl. C09K 8/504; E21B 21/00

(52) U.S. Cl. CPC C09K 8/5045; E21B 21/003

(57) ABSTRACT

A solids-laden fluid loss control pill comprises a base fluid, a viscosifier, a fluid loss control agent, and a blend of calcium carbonate particles having at least two different sizes, wherein at least a portion of the blend of calcium carbonate particles are synthetic calcium carbonate particles formed from captured carbon dioxide. The blend of calcium carbonate particles can include natural calcium carbonate particles. The fluid loss control pill is used in a fluid loss control operation in a well.

### TECHNICAL FIELD

Embodiments of the technology relate generally to fluid loss control pills using calcium carbonate particles formed from sequestered carbon dioxide.

### BACKGROUND

Wells are drilled into land and subsea formations in order to produce resources such as hydrocarbons (e.g., petroleum and natural gas) and also to inject fluids (water or gas) for reservoir pressure maintenance, enhanced oil recovery or fluid disposal. After a well is drilled, it is completed to prepare the well for producing the resources or for injection of fluids. Completion operations can involve placing a casing or liner in the drilled well, placing downhole tools and production tubing in the well, and perforating and stimulating the formation. Solids-laden fluid loss control pills are mixtures containing particles that form a filter cake to control fluid losses from the well to the formation during the completion operation. The filter cake formed by the fluid loss control pill can be formed on the face of the formation, on a screen placed adjacent to the formation face, or on a proppant pack placed adjacent to the formation face. Solids-laden fluid loss control pills also have applications in workover operations, which can involve repairing or stimulating a well. Improvements to fluid loss control pills are described in the following description and attached drawings.

### SUMMARY

In one example embodiment, the present disclosure is generally directed to a method of making a fluid loss control pill. The method comprises contacting an ammoniated aqueous solution with a carbon dioxide source producing a carbonated ammoniated aqueous solution; contacting the carbonated ammoniated aqueous solution with substrate particles to produce synthetic calcium carbonate particles comprising the substrate particles coated with calcium carbonate; and combining a blend of calcium carbonate particles with a base fluid, a viscosifier, and other fluid loss control agents to produce the fluid loss control pill. The blend of calcium carbonate particles having at least two sizes, wherein at least a portion of the blend comprises the synthetic calcium carbonate particles, and wherein the blend of calcium carbonate particles has a concentration of 30-150 lb/bbl of the fluid loss control pill composition.

The foregoing method can further include one or more of the following aspects. The at least two sizes of the blend of calcium carbonate particles can comprise sizes that are chosen from: very fine, fine, medium, and coarse grades. In one aspect, the synthetic calcium carbonate particles of the blend of calcium carbonate particles can have a range of sizes. In another aspect, the blend of calcium carbonate particles can comprise natural calcium carbonate particles and the synthetic calcium carbonate particles. The substrate particles can be one or more of: a) synthetic calcium carbonate, b) a naturally occurring mineral such as naturally occurring calcium carbonate, and c) a self-degrading polymeric material so that the substrate particles are acid soluble or self-degrading. The fluid loss control pill can further comprise a pH control agent such as one of magnesium oxide, sodium hydroxide, or potassium hydroxide. Additionally, the fluid loss control composition can further comprise one or more of an oxygen scavenger, a lubricant, and a biocide.

In another example embodiment, the present disclosure is directed to a fluid loss control pill. The fluid loss control pill can comprise: a base fluid, a viscosifier, a fluid loss control agent, and a blend of calcium carbonate particles having at least two different sizes, wherein at least a portion of the blend of calcium carbonate particles comprise synthetic calcium carbonate particles formed from captured carbon dioxide, and wherein the blend of calcium carbonate particles has a concentration of 30-150 lb/bbl of the fluid loss composition.

The foregoing fluid loss control pill can further comprise one or more of the following aspects. The synthetic calcium carbonate particles can be produced by contacting a carbonated ammoniated aqueous solution with substrate particles. The at least two sizes of the blend of calcium carbonate particles can comprise sizes that are chosen from: very fine, fine, medium, and coarse grades. In one aspect, the synthetic calcium carbonate particles of the blend of calcium carbonate particles can have a range of sizes. In another aspect, the blend of calcium carbonate particles can comprise natural calcium carbonate particles and the synthetic calcium carbonate particles. The substrate particles can be one or more of: a) synthetic calcium carbonate, b) a naturally occurring mineral such as naturally occurring calcium carbonate, and c) a self-degrading polymeric material so that the substrate particles are acid soluble or self-degrading. The fluid loss control pill can further comprise a pH control agent such as one of magnesium oxide, sodium hydroxide, or potassium hydroxide. Additionally, the fluid loss control pill can further comprise one or more of an oxygen scavenger, a lubricant, and a biocide.

In yet another example embodiment, the present disclosure is directed to a method of controlling fluid loss during completion of a well. The method can comprise: forming a blend of calcium carbonate particles produced from captured carbon dioxide, wherein at least a portion of the blend of calcium carbonate particles are synthetic calcium carbonate particles formed from captured carbon dioxide; combining the blend of calcium carbonate particles with a base fluid, a viscosifier, and a fluid loss control agent to produce a fluid loss control pill, wherein the blend of calcium carbonate particles has a concentration of 30-150 lb/bbl of the fluid loss control pill; and pumping the fluid loss control pill into the well to a location adjacent to a porous area of the formation.

The foregoing method can further include one or more of the following aspects. The calcium carbonate particles can be produced by contacting a carbonated ammoniated aqueous solution with substrate particles. The substrate particles can be one or more of: a) synthetic calcium carbonate, b) a naturally occurring mineral such as naturally occurring calcium carbonate, and c) a self-degrading polymeric material so that the substrate particles are acid soluble or self-degrading. In one aspect, the synthetic calcium carbonate particles of the blend of calcium carbonate particles can have a range of sizes. In another aspect, the blend of calcium carbonate particles can comprise natural calcium carbonate particles and the synthetic calcium carbonate particles.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments relating to methods and compositions for fluid loss control pills and therefore are not to be considered limiting of the scope of this disclosure. The principles illustrated in the example embodiments of the drawings can be applied to alternate methods and compositions. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1A illustrates a method of producing a fluid loss control pill comprising synthetic calcium carbonate particles in accordance with an example embodiment of the disclosure.

FIG. 1B illustrates a synthetic calcium carbonate particle produced using the method of FIG. 1A in accordance with an example embodiment of the disclosure.

FIG. 2A illustrates a method of producing a fluid loss control pill comprising synthetic calcium carbonate particles in accordance with an example embodiment of the disclosure.

FIG. 2B illustrates a synthetic calcium carbonate particle produced using the method of FIG. 2A in accordance with an example embodiment of the disclosure.

FIG. 3 illustrates a well in which a fluid loss control pill has been placed in accordance with an example embodiment of the disclosure.

FIG. 4 illustrates a method of placing a fluid loss control pill in a well in accordance with an example embodiment of the disclosure.

### DETAILED DESCRIPTION OF EXAMPLE EMBODIMENTS

The example embodiments discussed herein are directed to compositions and methods for forming and using fluid loss control pills comprising calcium carbonate particles formed from sequestered carbon dioxide. Conventional calcium carbonate particles are a common bridging additive used in solids-laden fluid loss control pills. Conventional calcium carbonate particles can form a filter cake that inhibits the flow of fluid from the well into the formation thereby preventing harm to the formation. Once fluid loss is under control, the calcium carbonate particles are also advantageous because they can be dissolved and removed with an acid treatment. Conventional calcium carbonate particles are typically extracted from naturally occurring sources such as limestone, dolomite, and marble natural rock formations. After the naturally occurring calcium carbonate ores are mined, the ores undergo a grinding process to produce calcium carbonate particles of the desired size for use in fluid loss control pills. In some cases, the calcium carbonate particles are mixed with other materials to achieve the desired fluid loss control properties. Alternatives to calcium carbonate particles that have been used in fluid loss control pills include rock salt, evaporated salt, soluble resins, and polylactic acid. However, calcium carbonate particles remain as a dominant choice for solids-laden fluid loss control pills.

One disadvantage of using naturally occurring calcium carbonate in fluid loss control pills is that the mining and processing of the calcium carbonate is a lengthy process that requires substantial amounts of energy. The mining equipment, transport vehicles, and grinding equipment may use a substantial amount of energy and such use could generate carbon dioxide that may be emitted into the atmosphere.

There have been a variety of efforts throughout various industries to reduce the amount of carbon dioxide released into the atmosphere. One method for reducing the amount of carbon dioxide emitted into the atmosphere is to capture carbon dioxide released during various activities and to sequester the carbon dioxide. Sequestered carbon dioxide can be stored using a variety of techniques. One technique involves combining the sequestered carbon dioxide with an aqueous solution to produce calcium carbonate, thereby sequestering the captured carbon dioxide in the produced calcium carbonate. Calcium carbonate produced from sequestered carbon dioxide can be referred to herein as synthetic calcium carbonate to distinguish it from the naturally occurring calcium carbonate that is mined and used in conventional calcium carbonate particles traditionally used in conventional fluid loss control pills. New applications that substitute synthetic calcium carbonate containing captured carbon dioxide in place of naturally occurring calcium carbonate provide additional opportunities to reduce the amount of carbon dioxide released into the atmosphere.

The example embodiments described herein can provide applications for replacing the naturally occurring calcium carbonate used in conventional fluid loss control pills with synthetic calcium carbonate particles comprising sequestered carbon dioxide. These applications provide multiple advantages. First, the energy used and the associated carbon dioxide emitted in connection with the mining, transporting, and processing of naturally occurring calcium carbonate can be reduced. Replacing a portion of the conventional calcium carbonate raw material with the synthetic calcium carbonate particles reduces the amount of raw material that otherwise must be mined and transported. Thus, reducing the costs and carbon dioxide emissions associated with mining and transporting the large volumes of calcium carbonate provides significant benefits. These benefits can be further maximized when the synthetic calcium carbonate formed from sequestered carbon dioxide can be formed at or near the wells where it is to be used.

Second, carbon dioxide emitted from other processes involving fossil fuel combustion or the carbon dioxide already present in the atmosphere can be captured and sequestered in the synthetic calcium carbonate particles used in fluid loss control compositions. When the synthetic calcium carbonate particles sequester carbon dioxide from the atmosphere or from a combustion process, the fluid loss control pill locks up carbon dioxide that would otherwise add to the total carbon dioxide in the atmosphere.

Therefore, given the foregoing benefits, using synthetic calcium carbonate particles containing sequestered carbon dioxide in a fluid loss control operation reduces the carbon dioxide emissions that may be associated with hydrocarbon producer or injector wells. As will be described further in the following examples, the methods and apparatus described herein improve upon prior art approaches to producing calcium carbonate particles for use in hydrocarbon producer or injector wells.

As used herein, the terms “sequestered carbon dioxide” and “captured carbon dioxide” refer to the process of gathering carbon dioxide from the atmosphere or directly from a combustion process, combining the carbon dioxide with an aqueous solution, and producing calcium carbonate that traps the carbon dioxide in a solid compound.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

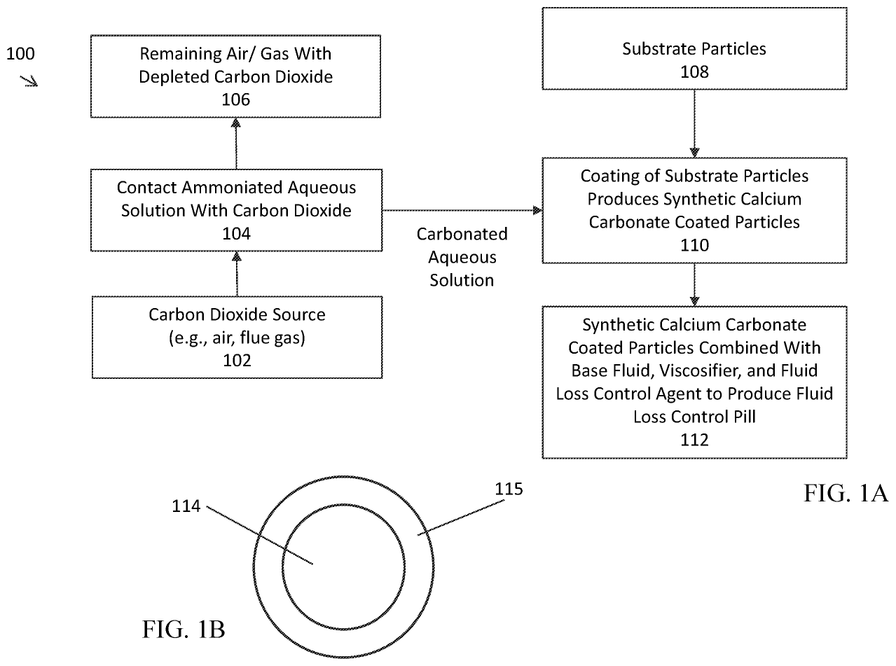

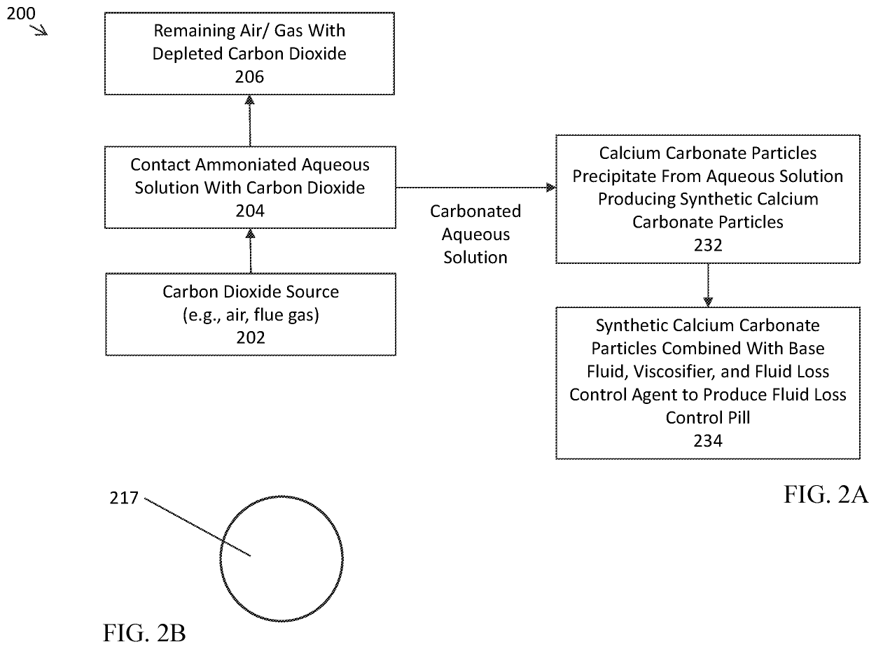

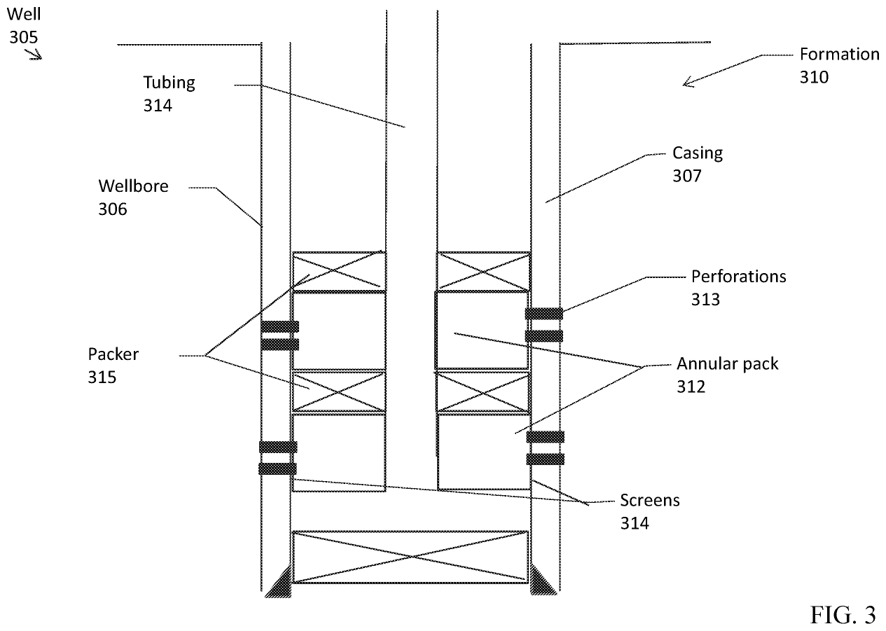

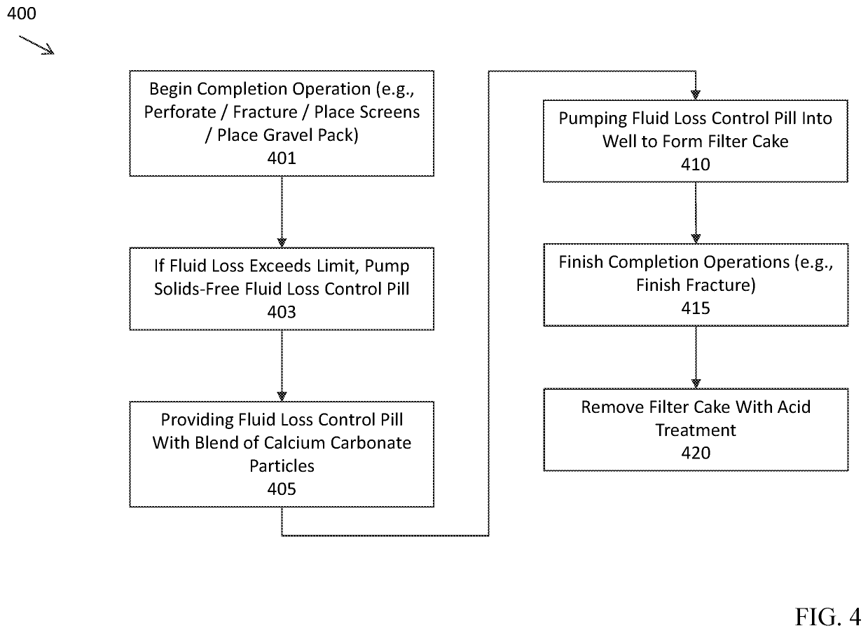

FIGS. 1A and 2A illustrate varying processes for manufacturing a fluid loss control pill with synthetic calcium carbonate particles that include sequestered carbon dioxide. The fluid loss control pill can also be referred to herein as a fluid loss control composition. FIGS. 1B and 2B illustrate the structure of the synthetic calcium carbonate particle produced according to each associated manufacturing process. FIG. 3 illustrates a hydrocarbon producer or injector well treated with a fluid loss control pill and FIG. 4 illustrates a method for treating a hydrocarbon producer or injector well with a fluid loss control pill in accordance with the example embodiments of this disclosure.

Referring to FIG. 1A, an example method 100 is illustrated for manufacturing a fluid loss control pill using synthetic calcium carbonate particles. In step 102, a source of carbon dioxide is gathered for use in the method 100. The source of carbon dioxide can be air from the atmosphere or flue gas from the burning of a hydrocarbon.

In step 104, the carbon dioxide is brought into contact with an ammoniated aqueous solution. While the carbon dioxide source in step 102 is typically in gas form such as air or flue gas, it should be understood that the state of the carbon dioxide can be modified for the purpose of contacting with the aqueous solution. For example, the carbon dioxide brought into contact with the ammoniated aqueous solution can be in the state of a gas, a liquid, a solid, or a mixture of one of these states. The carbon dioxide source can be brought into contact with the ammoniated aqueous solution by bubbling carbon dioxide gas through the solution or by mixing solid or liquid forms of the carbon dioxide with the fluid flow of the ammoniated aqueous solution. The carbon dioxide reacts with the ammoniated aqueous solution and produces carbonic acid, bicarbonate ions, and carbonate ions. The presence of calcium ions in the aqueous solution allows for a greater concentration of the carbon dioxide to be sequestered. It should be understood that in alternate embodiments, other divalent cations such as magnesium ions, can be included in the aqueous solution. After the carbon dioxide is contacted with the ammoniated aqueous solution, the remaining carbon dioxide source gas, which has now been depleted of the carbon dioxide absorbed in step 104, is discharged in step 106 having less carbon dioxide than when it was the original source gas in step 102. Thus, step 104 removes carbon dioxide from the carbon dioxide source and discharges a depleted carbon dioxide gas in step 106.

In step 108, substrate particles are gathered for introducing into the carbonated aqueous solution produced in step 104. The substrate particles can be any of a variety of particles that can be used as the base for the synthetic calcium carbonate particles that are to be formed using method 100. The substrate particles should be made from a material that can decompose or be dissolved so that they can be removed at the completion of the fluid loss control operation. Examples of substrate particles include, but not limited to a) a naturally occurring mineral such as naturally occurring calcium carbonate; b) synthetic calcium carbonate particles formed previously by a process such as method 100, and c) a self-degrading polymeric material. The substrate particles can be selected based on their size in order for the synthetic calcium carbonate particles produced by method 100 to have a size appropriate for use as a bridging material in a fluid loss control pill.

Referring to step 110, the substrate particles are submerged in the aqueous solution containing carbonates from step 104. While the substrate particles are submerged in the aqueous solution, calcium carbonate compositions precipitate and form a coating of calcium carbonate on the exterior of the substrate particles. The precipitation of the calcium carbonate compositions can be controlled in various ways, including, for example, controlling the temperature of the aqueous solution so that it is in the range of 5 to 70 degrees C. In other examples, other properties of the aqueous solution that can be controlled in order to control precipitation include adjusting the pH of the aqueous solution so that it is in the range of 9 to 14. The result of step 110 is a collection of particles consisting of the substrate particles coated with the synthetic calcium carbonate created by process 100.

FIG. 1B provides a cross-sectional illustration of a synthetic calcium carbonate particle produced in step 110. FIG. 1B shows the inner substrate particle 114 and the outer calcium carbonate coating 115. The calcium carbonate forms a hard shell on the substrate particles and traps the carbon dioxide that was absorbed into the aqueous solution as described in connection with step 104. The calcium carbonate shell formed on the substrate particles increases the diameter of the particles. As an example, the size of the synthetic calcium carbonate particles can be within one of four size grades typically used in the industry, namely, very fine (also referred to as ultra-fine), fine, medium, and coarse (which can also include extra or super coarse or extra extra course). The size grades represent a distribution of particle sizes. The following are typical numeric size ranges corresponding to the grade sizes of the synthetic calcium carbonate particles that may be appropriate for use in a fluid loss control pill in accordance with the embodiments described herein:
D50 of 2-8 microns: very fine (or ultra-fine)
D50 of 5-25 microns: fine
D50 of 50-150 microns: medium
D50 of 400-1200 microns: coarse (or extra or super coarse or extra extra course)

Referring to step 112 of FIG. 1A, the synthetic calcium carbonate particles produced in step 110 are combined with other materials to produce a fluid loss control pill. For example, other typical constituents of a fluid loss control pill that can be combined with the synthetic calcium carbonate particles include a base fluid, a viscosifier, and a fluid loss control agent. As an example, the base fluid can be a brine solution, whereas the viscosifier (e.g., xanthan gum) and fluid loss control (e.g., starches) agents can be polymers. Furthermore, other components can be added to the fluid loss control pill as appropriate for the particular conditions of a well, including one or more of: an oxygen scavenger (such as sodium sulfite, sodium bisulfite, ammonium bisulfite, sodium dithionite, sodium erythorbate, sodium thiosulfate, hydrazines, hydroxylamines, etc.), a lubricant (such as glycol and polyglycol, ethylene glycol, and polypropylene glycol-based, triglyceride and vegetable oil-based, fatty acid and glyceride-based systems), a biocide (such as glutaraldehyde, chlorinated phenols, isothiazolines, etc.), and a pH control additive (such as magnesium oxide, sodium hydroxide, or potassium hydroxide). Examples of concentrations for the constituents of the fluid loss control pill are provided below.

TABLE 1

| Additive | Typical additive concentrations | |
|---|---|---|
| Base fluid (brine) | As required for density | |
| Viscosifier | 0.75-2.0 | lb/bbl |
| Fluid Loss Control Agent | 3.0-8.0 | lb/bbl |
| pH control additive (e.g., Magnesium | 0.5-3.0 | lb/bbl |

| | |
|---|---|
| Oxide, or Sodium or Potassium | |
| Hydroxide | |
| CaCO3 or CaCO3 blend * | 30-150 lb/bbl (or 30-70 lb/bbl) |

Other additives based on operational conditions

| Oxygen Scavenger | 0.025% vol. (or 1 ppb) | |
|---|---|---|
| Lubricant | 2.0-7.0 ppb (or 1-5%) | |
| Biocide | 0.3-1.0 | ppb |

* Blends of CaCO3 can include two or more CaCO3 grade sizes: Very fine, fine, medium, coarse.

It should be understood that the constituents and the concentrations provided in the table above are non-limiting examples. In other embodiments of this disclosure, the concentrations can be varied or certain of the above-listed constituents can be omitted.

As noted in the table above, the calcium carbonate particles used in the fluid loss control pill typically are a blend of particles having different sizes to effectively form a filter cake to inhibit fluid flow into the pores of the formation. While not required, a blend of particles having different sizes can be more effective at forming a filter cake to inhibit fluid loss into the pores of the formation. The particle size distributions can be tailored to stop losses for particular applications, such as losses at a proppant pack, at a sand screen, or tailored to suit a particular formation porosity. As an example, the blend of particles can include coarse particles and very fine particles that combine to form an effective filter cake in the well. The synthetic calcium carbonate particles described herein provide flexibility in the way in which they can be blended and deployed in fluid loss control pills.

As one example, the fluid loss control pills described herein can use a blend of conventional (naturally occurring) calcium carbonate particles and synthetic calcium carbonate particles to achieve the desired varying sizes of particles to form an effective filter cake. The conventional calcium carbonate particles can be of a very fine or fine size, whereas the synthetic calcium carbonate particles can be of a medium or coarse size. The ratio of conventional calcium carbonate particles to synthetic calcium carbonate particles can be 50%:50%, 60%:40%; 70%:30%; 40%:60%; or 30%:70% by weight, as non-limiting examples.

Alternatively, in another example, the calcium carbonate particles used in the fluid loss control pill can be exclusively synthetic calcium carbonate particles having at least two different sizes. Certain of the synthetic calcium carbonate particles can be of a very fine or fine size, whereas others of the synthetic calcium carbonate particles can be of a medium or coarse size. The ratio of smaller synthetic calcium carbonate particles to larger synthetic calcium carbonate particles can be 50%:50%, 60%:40%; 70%:30%; 40%:60%; or 30%:70% by weight, as non-limiting examples.

The fluid loss control pill produced by method 100 can be used for treating a well as described further in connection with FIGS. 3 and 4. It should be understood that the example method 100 of FIG. 1A can be modified within the scope of this disclosure. For example, certain steps of method 100 may be altered. Moreover, additional steps may be added in sequence or in parallel to the method 100.

Referring now to FIG. 2A, a variation on the method of FIG. 1A is illustrated. Specifically, FIG. 2A illustrates example method 200. Example method 200 begins in the same manner as method 100 of FIG. 1A. Accordingly, it should be understood that steps 202 through 206 of FIG. 2A are substantially identical to steps 102 through 106 of FIG. 1A and the description of those steps applies to method 200 and will not be repeated. Example method 200 differs from example method 100 in that substrate particles are not used for forming the synthetic calcium carbonate particles. Instead, in step 232 calcium carbonate particles precipitate from the aqueous solution and directly form the synthetic calcium carbonate particles. In other words, instead of simply coating a substrate particle, the synthetic calcium carbonate particles produced in step 232 consist of the calcium carbonate that precipitates from the aqueous solution.

FIG. 2B provides a cross-sectional illustration of the synthetic calcium carbonate particle produced in step 232. As illustrated in FIG. 2B, the particle is formed from the calcium carbonate 217 that precipitates from the aqueous solution.

Referring to step 234, the synthetic calcium carbonate particles produced in step 232 are combined with other materials to produce a fluid loss control pill. For example, other typical constituents of a fluid loss control composition that can be combined with the synthetic calcium carbonate particles include a base fluid, a viscosifier, and a fluid loss control agent. As an example, the base fluid can be a brine solution, whereas the viscosifier and fluid loss control agents can be polymers. Furthermore, other components can be added to the fluid loss control pill as appropriate for the particular conditions of a well, including an oxygen scavenger (such as sodium sulfite, sodium bisulfite, ammonium bisulfite, sodium dithionite, sodium erythorbate, sodium thiosulfate, hydrazines, hydroxylamines, etc.), a lubricant (such as glycol and polyglycol, ethylene glycol, and polypropylene glycol-based, triglyceride and vegetable oil-based, fatty acid and glyceride-based systems), a biocide (such as glutaraldehyde, chlorinated phenols, isothiazolines, etc.), and a pH control additive (such as magnesium oxide, sodium hydroxide, or potassium hydroxide). The example concentrations provided above in Table 1 in connection with step 112 of FIG. 1 can also be used with the fluid loss control pill produced by method 200. Additionally, the discussion associated with FIG. 1A concerning blends of calcium carbonate particles having different sizes is equally applicable to the embodiment of FIGS. 2A and 2B.

The fluid loss control pill produced in step 234 can be used for treating a well as described further in connection with FIGS. 3 and 4. It should be understood that the example method 200 of FIG. 2A can be modified within the scope of this disclosure. For example, certain steps of method 200 or the components used in the method 200 may be altered. Moreover, additional steps may be added in sequence or in parallel to the method 200.

FIGS. 3 and 4 illustrate a method for treating a well with a fluid loss control pill such as the pills produced by the methods illustrated in FIGS. 1A and 2A. It should be understood that the example fluid loss control pills described herein can be applied in a variety of completion operations, including but not limited to perforation operations, hydraulic fracturing operations, wells having a cased hole frac pack (CHFP) completion, wells having an open hole gravel pack (OHGP) completion, and wells having a cased hole gravel pack (CHGP) completion.

Referring now to FIG. 3, a cross-section of a well 305 is illustrated. Well 305 can be located on land or could be a offshore well. Well 305 is defined by a wellbore 306 located in a formation 310 that comprises a hydrocarbon reservoir (not shown). The well 305 comprises a casing 307 and multiple annular packs 312 positioned between multiple packers 315. The annular packs 312 are positioned adjacent to perforations 313 in the casing 307 which are aligned with zones of the formation 310. The tubing 314 can be used to convey fluids into or out of the well 305.

As one example, a fluid loss control operation can be performed after the perforations 313 are formed in order to inhibit fluid flow from the well into the pores of the formation. As another example, a fluid loss control operation can be performed after a hydraulic fracturing operation to inhibit fluid flow from the well into the pores of the formation. The fluid loss control operation can use a fluid loss control pill such as the compositions described in connection with FIGS. 1A and 2A. The fluid loss control operation creates a filter cake along the formation, or along a screen 314 adjacent to the annular packs 312, or against a proppant pack, to protect the pores of the formation.

FIG. 4 illustrates an example method 400 for performing a fluid loss control operation using a fluid loss control pill such as those produced by the example methods of FIGS. 1A and 1B. In step 401, a completion operation is begun after a well is drilled. The completion operation can involve one or more of a variety of operations, including, a perforation, hydraulic fracturing, placing of sand screens in the well, or placing of gravel packs in the well. In step 403, if fluid loss from the well into the pores of the formation exceeds a determined limit, a fluid loss control pill can be pumped into the well to reduce the fluid loss. In such a situation, it is typical to begin by pumping a solids-free fluid loss control pill (a pill without solid particles) into the well. If the solids-free fluid loss control pill is inadequate to control the fluid loss, a fluid loss control pill containing solid particles, such as the pills described herein, can be used to control the fluid loss. Accordingly, in step 405, one of the example fluid loss control pills having a blend of calcium carbonate particles, as described herein, is provided. The blend of calcium carbonate particles includes at least a portion of synthetic calcium carbonate particles as described previously. In step 410, the fluid loss control pill is injected into the well in connection with the completion operation. For example, the fluid loss control pill can be pumped into well 305 using tubing 314 so that the fluid loss control composition is directed towards annular packs 312. At annular packs 312, the calcium carbonate particles of the fluid loss control composition form a filter cake along the face of the formation, and/or along a sand screen adjacent to the formation, and/or along the annular packs to reduce fluid loss into the pores of the formation.

With the filter cake in place, the pores of the formation are protected and the completion operation can be completed in step 415. Once the completion operation is finished, in step 420 the filter cake created with the calcium carbonate particles can be removed by applying an acid or other treatment solution. Calcium carbonate can be easily dissolved using an acid (such as hydrochloric acid, acetic acid, formic acid, or combinations thereof), therefore, the synthetic calcium carbonate provides is an easy-to-use alternative to conventional (naturally occurring) calcium carbonate. Additionally, if a substrate is used to form the synthetic calcium carbonate particles, a material that can be easily dissolved or degraded is also used for the substrate. It should be understood that method 400 is only one illustrative example and in alternate embodiments certain steps of method 400 may be altered.

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Terms such as “first”, “second”, “top”, “bottom”, “side”, “distal”, “proximal”, and “within” are used merely to distinguish one step or component from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A method of making a fluid loss control pill, the method comprising:
contacting an ammoniated aqueous solution with a carbon dioxide source producing a carbonated ammoniated aqueous solution;
contacting the carbonated ammoniated aqueous solution with substrate particles to produce synthetic calcium carbonate particles comprising the substrate particles coated with calcium carbonate; and
combining a blend of calcium carbonate particles with a base fluid, a viscosifier, and a fluid loss control agent to produce the fluid loss control pill, the blend of calcium carbonate particles having at least two sizes, wherein at least a portion of blend of calcium carbonate particles comprises the synthetic calcium carbonate particles, wherein the blend of calcium carbonate particles has a concentration of 30-150 lb/bbl of the fluid loss control pill.

2. The method of claim 1, wherein the at least two sizes of the blend of calcium carbonate particles comprises sizes that are chosen from: very fine, fine, medium, and coarse grades.

3. The method of claim 1, wherein the synthetic calcium carbonate particles of the blend of calcium carbonate particles have a range of sizes.

4. The method of claim 1, wherein the blend of calcium carbonate particles comprises natural calcium carbonate particles and the synthetic calcium carbonate particles, wherein the natural calcium carbonate particles have a different size relative to the synthetic calcium carbonate particles.

5. The method of claim 1, wherein the substrate particles are a self-degrading polymeric material.

6. The method of claim 1, wherein the fluid loss control pill further comprises one of magnesium oxide, sodium hydroxide, or potassium hydroxide.

7. The method of claim 1, wherein the fluid loss control pill further comprises one or more of an oxygen scavenger, a lubricant, and a biocide.

8. A fluid loss control pill comprising:
a base fluid;
a viscosifier;
a fluid loss control agent; and
a blend of calcium carbonate particles having at least two different sizes, wherein at least a portion of the blend of calcium carbonate particles are synthetic calcium carbonate particles formed from captured carbon dioxide, and wherein the blend of calcium carbonate particles has a concentration of 30-150 lb/bbl of the fluid loss control pill.

9. The fluid loss control pill of claim 8, wherein the synthetic calcium carbonate particles are produced by contacting a carbonated ammoniated aqueous solution with substrate particles.

10. The fluid loss control pill of claim 8, wherein the at least two different sizes of the blend of calcium carbonate particles comprises sizes that are chosen from: very fine, fine, medium, and coarse grades.

11. The fluid loss control pill of claim 8, wherein the synthetic calcium carbonate particles of the blend of calcium carbonate particles have a range of sizes.

12. The fluid loss control pill of claim 8, wherein the blend of calcium carbonate particles comprises natural calcium carbonate particles and the synthetic calcium carbonate particles, wherein the natural calcium carbonate particles have a different size relative to the synthetic calcium carbonate particles.

13. The fluid loss control pill of claim 9, wherein the substrate particles are a self-degrading polymeric material.

14. The fluid loss control pill of claim 8, wherein the fluid loss control pill further comprises one of magnesium oxide, sodium hydroxide, or potassium hydroxide.

15. The fluid loss control pill of claim 8, wherein the fluid loss control pill further comprises one or more of an oxygen scavenger, a lubricant, and a biocide.

16. A method of controlling fluid loss during completion of a well, the method comprising:
forming synthetic calcium carbonate particles by contacting substrate particles with a carbonated ammoniated aqueous solution to form a synthetic calcium carbonate coating on the substrate particles, wherein the carbonated ammoniated aqueous solution comprises captured carbon dioxide;
forming a blend of calcium carbonate particles, wherein at least a portion of the blend of calcium carbonate particles are the synthetic calcium carbonate particles;
combining the blend of calcium carbonate particles with a base fluid, a viscosifier, and a fluid loss control agent to produce a fluid loss control pill, wherein the blend of calcium carbonate particles has a concentration of 30-150 lb/bbl of the fluid loss control pill; and
injecting the fluid loss control pill into the well to a location adjacent to a porous area of a formation in which the well is located.

17. The method of claim 16, wherein the fluid loss control pill forms a filter cake on a formation face of the well.

18. The method of claim 17, wherein the substrate particles are a self-degrading polymeric material.

19. The method of claim 16, wherein the synthetic calcium carbonate particles of the blend of calcium carbonate particles have a range of sizes.

20. The method of claim 16, wherein the blend of calcium carbonate particles comprises natural calcium carbonate particles and the synthetic calcium carbonate particles, wherein the natural calcium carbonate particles have a different size relative to the synthetic calcium carbonate particles.
